(19) United States
(12) Patent Application Publication
(10) Pub. No.: US 2012/0232723 A1
(43) Pub. Date: Sep. 13, 2012

(54) Method to Increase Aircraft Maximum Landing Weight Limitation

(76) Inventor: C. Kirk Nance, Keller, TX (US)

(21) Appl. No.: 13/452,996

(22) Filed: Apr. 23, 2012

Related U.S. Application Data
(63) Continuation-in-part of application No. 12/469,976, filed on May 21, 2009, now Pat. No. 8,180,504.

(51) Int. Cl. G05D 1/06; B64C 25/02

(52) U.S. Cl. 701/5

(57) ABSTRACT

A method of establishing a justification basis to Aircraft Regulatory Authorities, to allow for a reduction in aircraft sink-speed assumptions. To further allow the aircraft to operate an increased maximum landing weight limitation. A system for use in measuring aircraft vertical velocity at initial contact with the ground, experienced while aircraft are executing either normal or hard landing events. Pressure sensors are attached to the working pressure within the landing gear strut, so to monitor in-flight landing gear strut pre-charge pressure, until such time as the pre-charge pressure suddenly increases, to detect the aircraft has come into initial contact with the ground. Rotation sensors are attached to the hinged elements of the landing gear strut, so to monitor in-flight landing gear strut extension, until such time as the strut extension suddenly decreases, to detect the aircraft has come into initial contact with the ground.

This application claims the benefit of U.S. provisional patent application Ser. No. 12/469,976, filed May 21, 2009.

### BACKGROUND OF THE INVENTION

An aircraft is typically supported by plural pressurized landing gear struts. Designs of landing gear incorporate moving components which absorb the impact force of landing. Moving components of an aircraft landing gear shock absorber are commonly vertical telescopic elements. The telescopic shock absorber of landing gear comprise internal fluids, both hydraulic fluid and compressed nitrogen gas, and function to absorb the vertical descent forces generated when the aircraft lands.

The amount of force generated when an aircraft lands is a function of the aircraft weight at landing, and the vertical velocity at which that aircraft landing weight comes into initial contact with the ground. Aircraft have limitations regarding the maximum allowable force the aircraft landing gear and other supporting structures of the aircraft can safely absorb when the aircraft lands. Landing force limitations, which are often related to aircraft vertical velocity (sink-rate or sink-speed) at initial contact with the ground, are a key factor in determining the Maximum Landing Weight (“MLW”) for aircraft. The MLW limitation is related to an assumed aircraft Vertical Velocity at initial contact with the Ground (“hereinafter referred to as: VVG”).

Aircraft routinely depart from an airport with the aircraft weight less than the maximum take-off weight limitation, but greater than the maximum landing weight limitation. During the flight in-route fuel is consumed, which reduces the aircraft weight to a value below the maximum landing weight limitation. On average, passenger airlines dispatch about 28,537 flights per day. With this high volume of daily flights, situations such as medical emergencies or minor equipment malfunctions often arise where an aircraft has left the departure airport, and the pilot discovers the need to immediately return and land, without the time or opportunity to burn-off the planned in-route fuel. This causes an overweight landing event. When an overweight landing occurs, the Federal Aviation Administration (hereinafter referred to as “FAA”) in accordance with the aircraft manufacturer recommendations, require the aircraft be removed from service and a manual inspection be performed to check for damage to the landing gear and the connection fittings of the landing gear to the aircraft.

Airlines must perform complex calculations of determining passenger weights, baggage weights and cargo weights; before each flight, to assure the aircraft' actual landing with is below the MLW limitation.
As an example: a domestic airline which operates the Embraer 145 aircraft had a flight departing from a Midwest airport. The flight was planned where passengers, bags and fuel were added to the aircraft, with the planned fuel burn having the aircraft landing with a weight just below the MLW limitation. Weather forecasts had the possibility of severe storms passing through the area of the destination airport. The pilot being concerned about the potential storms creating a need to delay the schedule arrival time, thus ordered an additional 1,000 lbs of “storm-fuel” to be added to the aircraft; to allow additional time to circle the destination city, and land after the potential storms had past. Prior to that departure, airline agents came aboard the aircraft and requested that 5 passengers be removed from the flight (each passenger having an assigned weight, including their carryon bags, as 200 lbs). The required removal of the 5 passengers was due to the possibility that the severe storms would not develop, nor pass through the destination airport; thus the aircraft would not need to burn-off the additional storm-fuel, which would have the arriving aircraft landing 1,000 lbs over the MLW limitations.

Because an overweight landing causes the aircraft to be removed from service for inspection, which severely disrupts the airline's planned operations, airlines work to avoid such events. As a result, aircraft operators will restrict the planned load, and an aircraft may take-off with un-used capacity. The weight carrying ability of the aircraft is thus limited, not by the maximum take-off weight limitation, but by the MLW limitation.

The landing weight is limited by FAA Regulation. In studying the regulation and its history, an important realization can be made.

The FAA is the Regulatory Authority which regulates the design, development, manufacture, modification and operation of all aircraft operated within the United States, and will be used along with the term “Regulatory Authority” to indicate both the FAA and/or any governmental organization (or designated entity) charged with the responsibility for either initial certification of aircraft or modifications to the certification. Examples of Regulatory Authorities would include: European Aviation Safety Agency “EASA”, within most European countries; Transport Canada, Civil Aviation Directorate “TCCA”, in Canada; Agência Nacional de Aviação Civil “ANAC” in Brazil; or other such respective Regulatory Authority within other such respective countries.

FAA Regulations (provided in the Code of Federal Regulations) are the governmental regulations which detail the requirements necessary for an aircraft to receive certification by the Regulatory Authority within the United States. These would be equivalent to such regulations within the Joint Aviation Regulations “JARs” which are used in many European countries.

Title 14 of the Code of Federal Regulations, Part 25 refers to regulations which control the certification of Air Transport Category aircraft “Part 25 aircraft”. Part 25 aircraft include most of the commercial passenger aircraft in use today. For example, Part 25 aircraft includes Boeing model numbers 737, 747, 757, 767, 777; Airbus A300, A310, A320, A330, A340, etc.

In particular §25.473(a) provides:

Today an aircraft's MLW limitation is governed by these 66 year old regulatory assumptions, whereby an aircraft manufacturer must design and demonstrate the structural integrity of the aircraft and landing gear, to allow for the weight of that aircraft to land at MLW, with a VVG of 10 fps, with no damage to the aircraft.

Chapter §25.473 also requires demonstration that the aircraft can safely landed at reduced VVG rates, which are assumed not to exceed 6 fps, at the higher maximum takeoff weight “MTOW.” This event is allowed only in emergency or non-scheduled events, and an over-weight landing inspection is required immediately after such over-weight landing event. Though current regulations for aircraft design criteria acknowledge aircraft structural integrity to allow the aircraft to land at a weight greater than the originally certified MLW for that aircraft, with there being no active and operational system to accurately measure the VVG of those higher landing weight aircraft, there have been no justifications for the aviation Regulatory Authorities to allow for planned or scheduled landing events at the higher weights.

The previous paragraphs have the words “assumption” and “assumed” underlined. The FAA Regulations for the design criteria of Part 25 aircraft have the VVG of an aircraft as an assumed value, not as a measured value. This is a very important consideration, in the reasoning of the methods and strategies of this invention. There were no systems to measure aircraft VVG in 1945. From then, until today, there has been no justification basis provided to the FAA to modify the 10 fps assumption. Various systems have been developed for use within the current scope of the 10 fps requirements, but used only to better identify the extreme landing loads near, and in excess of 10 fps, experienced during aircraft landing mishaps. These different systems are not being used as part of a combined apparatus and method to demonstrate a justification basis for the reduction of the aircraft limit descent velocity assumption, for determining a second higher aircraft MLW limitation.

When aircraft leave a manufacture's assembly facility, there are no assurances that all subsequent landing events will be soft or smooth. FAA Regulations historically take the approach of “plan for the worst and hope for the best”, thus leaving the 10 fps assumption still in effect today.

The determination of vertical velocity at the exact moment of initial contact with the ground is a critical factor in efforts to convince the Regulatory Authorities in requests for modifications in current regulations regarding sink-rate assumptions and further to allow for increase in MLW, as function of better determination of aircraft VVG.

This invention offers the utilization of various prior art apparatus to measure aircraft VVG, in support of the methods of this new invention for an increase in the aircraft MLW limitation.

One aspect of this invention offers the utilization of (Nance) U.S. Pat. No. 7,274,309 which teaches the use of monitoring landing gear strut pressure, to further measure the collapse/compression rate of the telescopic landing gear strut. When this collapse rate of the telescopic landing gear is corrected as to vertical, it will identify the vertical sink-rate of the aircraft, at initial touch-down, at each respective landing gear. (Nance) U.S. Pat. No. 7,274,310 teaches the use of monitoring landing gear strut pressure, to measure the Kinetic Energy generated and dissipated by the aircraft landing gear, at initial touch-down, at each respective landing gear. The additional capability to measure the Kinetic Energy generated and dissipated at each landing gear strut, as opposed to the reliance on mere aircraft sink-rate assumptions, allows the justification for Regulatory Authorities to allow an increase in the aircraft MLW limitation.

Another aspect the invention offers the use of (Nance) U.S. Pat. No. 7,193,530 which teaches the use of a rotation sensor attached at the hinge point of the landing gear torque-links to monitor angle changes which measure the telescopic landing gear strut collapse/compression rate, and when this collapse rate of the telescopic landing gear is corrected as to vertical, identifies the vertical sink-rate of the aircraft, at initial touch-down, at each respective landing gear.

In still another aspect, the invention offers the use of (Nance) U.S. Pat. No. 8,042,765 which teaches the use of aircraft hull-mounted cameras to monitor telescopic collapse of the landing gear strut and image recognition software to calculate the collapse/compression rate of the landing gear strut; which further teaches the use of both laser and sonic range-finders to measure the compression rate of the aircraft landing gear strut.

Additional research of the prior art identifies numerous systems which measure whole aircraft descent velocity. Reference is made to U.S. Pat. No. 3,712,1228—Harris; U.S. Pat. No. 6,012,001—Scully, and U.S. Pat. No. 4,979,154—Brodeur. These and other patents describing similar but subtly different techniques teaching the use of various range-finder devices, attached to the aircraft hull, which measure the distance between the aircraft hull and the ground, as well as the rate of change of those measurements.

As a practical matter, obtaining accurate data on aircraft VVG, whether by monitoring the rate of landing gear strut compression, or by some other range-finder apparatus available through prior art, provides the pathway of seeking modification in the regulatory assumptions on sink-speed, which in turn would justify Part 25 aircraft to have MLW limitations increased. Although the assumption of 10 fps in the design criteria of the existing regulations have been in effect for over 6 decades, recent data shows that the assumption provides a very large safety margin. The FAA William J. Hughes Technical Center (FAA's Research and Development Division, “FAA Tech Center”) has made efforts to determine the rate of typical VVG landing events. Beginning in 1993 and running through 2008, the FAA Tech Center has completed multiple studies of aircraft landing parameters, including aircraft sink-speeds, at multiple airports located around the world, in efforts to accumulate more data regarding the landing events of daily airline operations. The FAA Tech Center survey used high-speed digital cameras, positioned at the “landing threshold zone” of the various airport runways and measure aircraft landing parameters for a large number of Part 25 aircraft. The most recent FAA Tech Center survey data, recorded during 2008, documents the “mean” or “average” VVG range, which is approximately 2 fps. (VVG, as in the Tech Center report is referred to as “Sink Speed”).
{http://www.tc.faa.gov/its/worldpac/techrpt/ar04-47.pdf}

The Regulatory Authorities have various practices to provide relief or modification to the regulatory requirements, such as:
Equivalent Level of Safety
Special Condition
Exemption
   This relief is normally granted by the Regulatory Authority, after demonstration and/or analysis of an alternate means of compliance, which verifies compliance with the intent of the regulation, without showing literal compliance to the regulation.

Another aspect of this invention is a method by which Part 25 aircraft are justified in receiving relief from the 10 fps assumption, to a lower assumption whereby the MLW of that Part 25 aircraft may be increased and acknowledged by aviation Regulatory Authorities. One of the methods of this invention involves analysis of the FAA Tech Center landing survey data, combined with development and implementation of set of new daily operational requirements for the Part 25 aircraft; thus providing by either: a demonstration and/or analysis to substantiate, a finding of an “Equivalent Level of Safety” and/or “Special Condition”.

The FAA defines and Equivalent Level of Safety (ELOS) as follows:
“Equivalent level of safety findings are made when literal compliance with a certification regulation cannot be shown and compensating factors exist which can be shown to provide an equivalent level of safety.”
   {http://rgl.faa.gov/Regulatory_and_Guidance_Library/rgELOS.nsf/}

The FAA issues a finding of ELOS during the process of certification, whether that be the initial certification of an aircraft, certifications of derivative aircraft the manufacturer may develop or when issuing a Supplemental Type Certificate for modifications to an aircraft type, developed by entities other than the manufacturer.

In the case of the methods of this invention, a demonstration of “literal compliance” with the regulatory design assumption (10 fps) cannot be shown, however the “compensating factors” which exist to substantiate the ELOS finding include:
The incorporation of apparatus and methods to measure, record and display (or generate alerts) when defined VVG thresholds are exceeded and, one or more of the following additional elements:
   The Approved Flight Manual for the aircraft contains specific VVG limits with which the aircraft must apply and provides for compliance with the traditional 10 fps limiting landing weight, if the VVG measuring system is inoperative;
   Apparatus and methods for recording the VVG for all landings in support of a trend monitoring system to monitor the life “experience” of both the airframe and individual landing gear;
   Alerting to the flight deck crew after a landing in which the VVG exceeds one or more pre-defined thresholds and supported by corresponding log book entry and/or inspection requirements.

The FAA defines Special Condition as follows:
“A Special Condition is a rulemaking action that is specific to an aircraft type and often concerns the use of new technology that the Code of Federal Regulations does not yet address. Special Conditions are an integral part of the Certification Basis and give the manufacturer permission to build the aircraft, engine or propeller with additional capabilities not referred to in the regulations.”
   {http://rgl.faa.gov/Regulatory_and_Guidance_Library/rgSC.nsf/}

A Regulatory Authority may wish to approve such installation, use and regulatory relief from such a System, by the issuance of a Special Condition as an alternative to the granting approval established by an ELOS, based upon no regulatory requirement or definition of a System which measures VVG. Regardless of the regulatory approval path used, the System attributes would be the same.

### SUMMARY OF THE INVENTION

There is provided a method of operating an aircraft, the aircraft having a first maximum landing weight based upon a first assumed maximum descent velocity. Vertical velocities are obtained of the aircraft at initial contact of the aircraft with the ground during landing events. Based upon the obtained vertical velocities of the aircraft at initial contact with the ground, operating the aircraft at or below a second assumed maximum descent velocity while measuring and recording the vertical velocities of the aircraft at initial contact of the aircraft with the ground during subsequent landing events, the second assumed maximum descent velocity being less than the first assumed maximum descent velocity. Operating the aircraft at a second maximum landing weight based upon the second assumed maximum descent velocity.

In accordance with another aspect, the second maximum landing weight is greater than the first maximum landing weight.

In accordance with another aspect, the step of obtaining vertical velocities of the aircraft at initial contact of the aircraft with the ground during landing events further comprises the step of measuring and recording the descent velocities of the aircraft at initial contact of the aircraft with the ground, during landing events.

In accordance with another aspect, the aircraft has landing gear. Each landing gear comprises a telescopic strut which is capable of extension and compression. The step of measuring a vertical velocity of the aircraft at initial contact of the aircraft with the ground during subsequent landing events further comprises the steps of measuring the extension of the one of the telescopic struts before contact of the respective landing gear with the ground, measuring the extension of the one telescopic strut during initial contact of the respective landing gear with the ground; measuring the amount of changed extension of the one telescopic strut with respect to elapsed time; determining the rate of compression of the one telescopic strut; and determining the descent velocity of the aircraft portion of the one telescopic strut is determined by the increasing pressure within the strut, or by change in torque-link angle; which relates to the compression rate of the landing gear strut.

In accordance with still another aspect, the step of measuring a vertical velocity of the aircraft at initial contact with the ground during subsequent landing events further comprises providing a rangefinder on the hull of the aircraft, the rangefinder directed down to the ground; measuring the distance to the ground of the aircraft over elapsed time before the landing gear makes initial contact with the ground; determining when the landing gear makes initial contact with the ground and determining the descent velocity of the aircraft at initial contact by the landing gear with the ground.

In accordance with another aspect, the step of measuring a vertical velocity of the aircraft at initial contact with the ground during subsequent landing events further comprises providing a accelerometer on the hull of the aircraft, measuring the acceleration of the aircraft hull over elapsed time before the landing gear makes initial contact with the ground; determining when the landing gear makes initial contact with the ground; and determining the descent velocity of the aircraft at initial contact by the landing gear with the ground.

In accordance with still another aspect, the step of measuring a vertical velocity of the aircraft at initial contact with the ground during subsequent landing events further comprises providing a global positioning system receiver on the aircraft; measuring the location of the aircraft hull above the ground over elapsed time before the landing gear makes initial contact with the ground; determining when the landing gear makes initial contact with the ground; and determining the descent velocity of the aircraft at initial contact by the landing gear with the ground.

In accordance with another aspect, wherein the first assumed maximum descent velocity is 10 fps.

In accordance with another aspect, wherein the step of operating the aircraft at a second assumed maximum descent velocity that is less than 10 fps further comprises the step of operating the aircraft at or below a second assumed maximum descent velocity of 9.8 fps.

In accordance with another aspect, wherein the step of operating the aircraft at a second assumed maximum descent velocity that is less than 10 fps further comprises the step of operating the aircraft at or below a second assumed maximum descent velocity of 9.6 fps.

In accordance with another aspect, the step of operating the aircraft at a second assumed maximum descent velocity that is less than 10 fps further comprises the steps of measuring and recording the vertical velocity of the aircraft at initial contact of the aircraft with the ground during a landing event, determining if the vertical velocity exceeds a predetermined threshold, and if the vertical velocity exceeds a predetermined threshold, then inspecting the aircraft before resuming flight operations.

There is also provided a method of operating an aircraft, the aircraft having a maximum landing weight based upon a first assumed maximum descent velocity. The descent velocities of the aircraft at initial contact of the aircraft with the ground, during landing events are measured and recorded. Determining if a measured descent velocity of the aircraft at initial contact with the ground exceeds a predetermined threshold. Inspecting the aircraft, upon determining if the measured descent velocity exceeds the predetermined threshold. Operating the aircraft at a second assumed maximum descent velocity that is less than the first assumed maximum descent velocity. Operating the aircraft at a second maximum landing weight that is greater than the first maximum landing weight, based upon the second assumed maximum descent velocity.

In accordance with another aspect, the aircraft has landing gear, each landing gear comprising a telescopic strut which is capable of extension and compression, the step of measuring a vertical velocity of the aircraft at initial contact of the aircraft with the ground during a landing event further comprises the steps of measuring the extension of the one of the telescopic struts before contact of the respective landing gear with the ground, measuring the extension of the one telescopic strut during initial contact of the respective landing gear with the ground, measuring the amount of changed extension of the one telescopic strut with respect to elapsed time, determining the rate of compression of the one telescopic strut, and determining the descent velocity of the aircraft portion of the one telescopic strut.

In accordance with still another aspect, the step of measuring the descent velocity of the aircraft at initial contact with the ground during landing events further comprises providing a rangefinder on the hull of the aircraft, the rangefinder directed down to the ground; measuring the distance to the ground of the aircraft over elapsed time before the landing gear makes initial contact with the ground; determining when the landing gear makes initial contact with the ground; and determining the descent velocity of the aircraft at initial contact by the landing gear with the ground.

In accordance with still another aspect, the step of measuring the descent velocity of the aircraft at initial contact with the ground during landing events further comprises providing an accelerometer of the hull of the aircraft; measuring the acceleration of the aircraft hull over elapsed time before the landing gear makes initial contact with the ground; determining when the landing gear makes initial contact with the ground; and determining the descent velocity of the aircraft at initial contact by the landing gear with the ground.

In accordance with another aspect, the step of measuring the descent velocity of the aircraft at initial contact with the ground during landing events further comprises providing a global positioning system receiver on the aircraft; measuring the location of the aircraft hull above the ground over elapsed time before the landing gear makes initial contact with the ground; determining when the landing gear makes initial contact with the ground; and determining the descent velocity of the aircraft at initial contact by the landing gear with the ground.

### BRIEF DESCRIPTION OF THE DRAWINGS

Although the features of this invention, which are considered to be novel, are expressed in the appended claims, further details as to preferred practices and as to the further objects and features thereof may be most readily comprehended through reference to the following description when taken in connection with the accompanying drawings, wherein:

FIG. 1 is a side view of a typical transport category aircraft with nose and main landing gear deployed.

FIGS. 2a, 2b, and 2c are views of a transport category aircraft showing respectively: on final approach descending towards the ground; executing a proper flare procedure to reduce vertical velocity prior to initial contact with the ground; and making “initial contact” with the ground.

FIG. 3 is “Table 2, page 10” taken from DOT/FAA/AR-08/12: VIDEO LANDING PARAMETER SURVEYS—CINCINNATI/NORTHERN KENTUCKY AND ATLANTIC CITY INTERNATION AIRPORTS, being the FAA Tech Center Survey Data comparing aircraft landing parameters, illustrating in particular: Average Sink Speed—for various aircraft models.

FIG. 4 is a table showing an example of the relationships of reduced vertical velocity assumptions to increasing aircraft MLW “maximum landing weight” limitations.

FIGS. 5a, 5b and 5c are sequential side views of a vertical telescopic landing gear strut, shown with various amounts of compression, both a pre-touchdown fully extended posture, then post-touchdown initially compressed posture, as compared to elapsed time; with illustrations of Software Program “Alpha”—landing gear pressure monitoring, and Software Program “Beta”—landing gear compression rate monitoring.

FIGS. 6a, 6b and 6c are sequential side views of an alternate design for aircraft landing gear strut, shown with various amounts of compression, both a pre-touchdown fully extended posture then post-touchdown initially compressed posture, as compared to elapsed time; with illustrations of Software Program “Gamma”—torque-link angle monitoring, and Software Program “Delta”—landing gear trailing arm strut compression rate monitoring.

FIGS. 7a and 7b are an illustration of Software Program “Epsilon”—aircraft hull angle correction to horizontal, which uses inclinometer data to correct rate of strut compression calculations for non-level aircraft angle.

FIGS. 8a, and 8b are an illustration of Software Program “Zeta”—aircraft Vertical Velocity at initial contact with the Ground “VVG”, threshold and exceedance determination.

FIG. 9 is an apparatus block diagram illustrating the computer, various Software Programs; with inputs from pressure sensors, rotation sensors and inclinometer of the present invention, in accordance with a preferred embodiment.

FIG. 10 is a view of a process design flow chart for a “Method of Obtaining Modification to Limit Descent Velocity Assumptions.

FIG. 11 is a view of a process design flow chart for a “Method of Obtaining and Implementing Increased Maximum Landing Weight” for aircraft.

FIG. 12 is view of a process design flow chart, for required post-landing actions, to be followed by aircraft Flight Crew and Maintenance Control personnel, upon observance of measurement indications, from sink speed measuring system.

### DETAILED DESCRIPTION OF THE

### Preferred Embodiment

The present invention creates a “justification basis” for a Regulatory Authority to allow for a reduction in the current regulatory assumptions of aircraft sink-speed or VVG, by use of measured VVG, to further allow an increase in the MLW limitation of the aircraft. The present invention incorporates devices which measure and determine aircraft sink-speed through various methods including the compression rate experienced by each landing gear strut on initial contact with the ground. The strut is monitored for compression so as to confirm that the aircraft has come into contact with the ground and also to determine the rate of strut compression and the aircraft vertical descent velocity or VVG.

The present invention detects initial and continued compression of the landing gear strut by rapidly monitoring angle changes in landing gear torque-link, and/or internal strut pressure, prior to initial contact with the ground; as well as throughout the remainder of the landing event. Measurements of vertical compression are monitored at a very rapid rate and are stored within a computer which is part of the system. The computer then compares changes in strut pressure to determine the amount of strut compression in relation to elapsed time. Strut compression includes strut extension and compression.

The present invention works with various types of telescopic strut designs, including true vertical strut designs, as well as trailing arm strut designs. The rate of strut compression corrected for aircraft hull inclination to horizontal, is the vertical velocity of the aircraft as it comes into initial contact with the ground.

The trailing arm landing gear has a different design than the vertical strut design. The trailing arm design forms a triangle with the three sides consisting of: a primary vertical strut body, a hinged trailing arm and a telescopic shock absorber. As the hinged trailing arm of landing gear rotates during strut compression, the opposing side of the hinged angle is a telescopic shock absorber, which will become shorter; changing the geometry of the triangle. The changing geometry, measured against elapsed time, will determine the vertical compression rate of the trailing arm landing gear design. The detection and rate of landing gear strut movement are determined during the initial contact of the landing gear with the ground. Upon detection of the initial movement of a respective landing gear strut, the step of monitoring the rate and amount of additional strut compression is used to determine the initial touch-down and VVG for each respective landing gear strut.

This invention provides methods of identifying, defining and illustrating various means of justification for Aviation Regulatory Authorities to allow for modifications to the design criteria regulations for transport category aircraft. The methods described herein develop various strategies for the justification of reductions to assumed limit descent velocity design criteria, from the current value of 10 fps, along with the related increase in the aircraft MLW limitation.

Use of apparatus which measure aircraft VVG, along with the use of methods and strategies for the review, analysis and documentation of FAA Regulations and FAA Tech Center aircraft sink-speed survey data which illustrate current Part 25 Chapter §25.473 limit descent velocity assumptions being more than adequate, creates operational procedures safer than what would be considered an Equivalent Level of Safety. Current Part 25 aircraft operational procedures provide no means for actual measurement and display of aircraft VVG to the aircraft flight crew, where this new invention offers methods of using measured VVG to allow for reduction to Part 25 Chapter §25.473 limit descent velocity assumptions, and the associated increase in aircraft MLW. The methods of this new invention further develop strategies for new requirements, for implementation of operational procedures to assure Regulatory Authorities; that allowing a reduction in the limit descent velocity assumption with its subsequent increase in Part 25 aircraft MLW, will offer an Equivalent Level of Safety, and an alternative means of regulatory compliance.

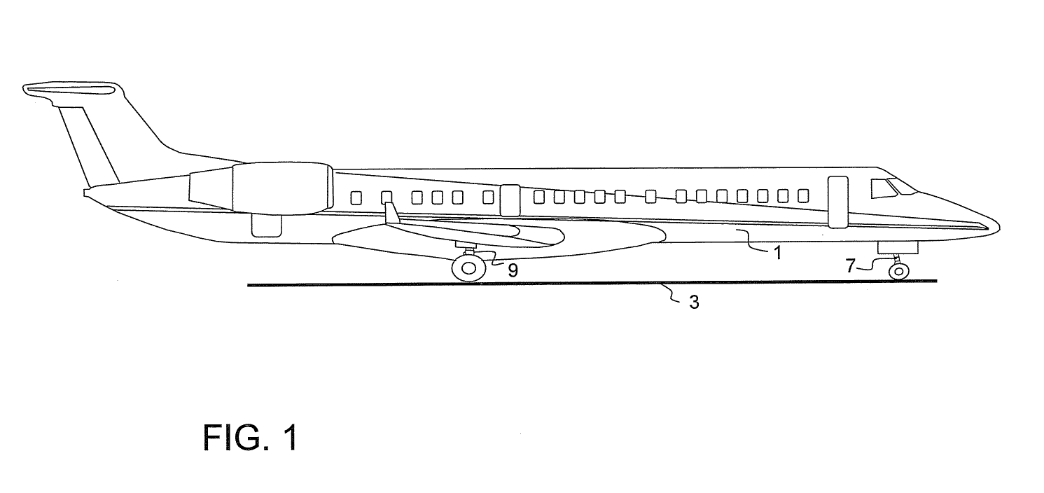

Referring now to the drawings, wherein like reference numerals designate corresponding parts throughout the several views and more particularly to FIG. 1 thereof, there is shown a typical transport category aircraft 1, resting on the ground 3, supported by as shown, one of the plural main landing gear 9, and a single nose landing gear 7.

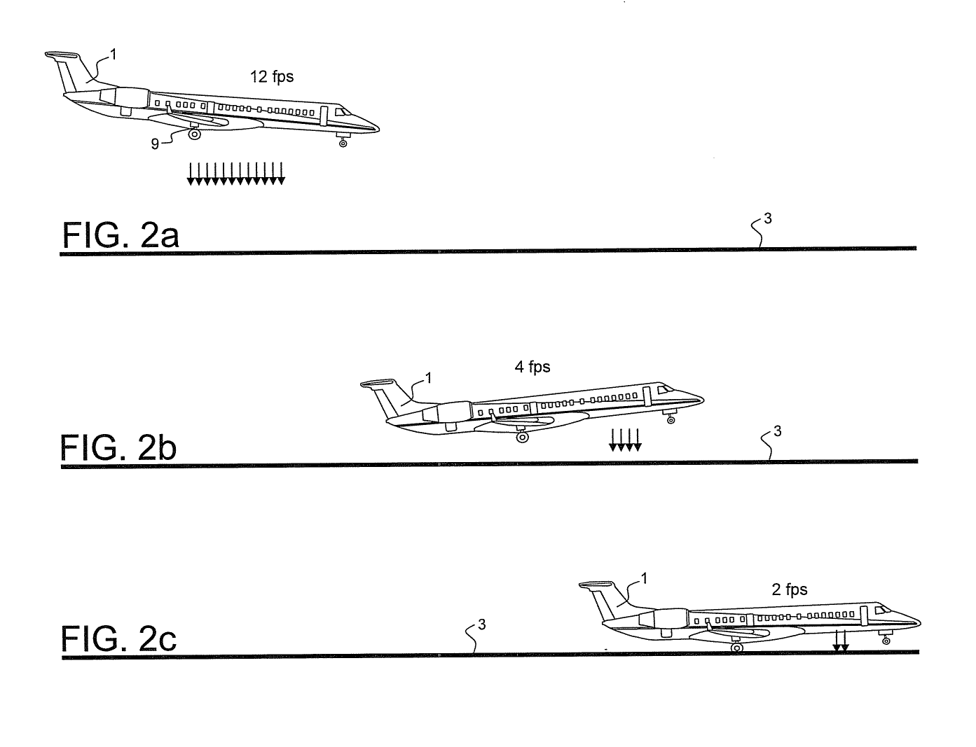

Referring now to FIG. 2a there is shown the transport category aircraft 1 in a typical landing approach posture, as it descends toward the ground 3. Deployed from the lower body of aircraft 1, are main landing gear 9. Main landing gear 9 absorbs the initial landing forces as aircraft 1 come into initial contact with the ground 3. Each of the downward pointing arrows (↓) represents the equivalent of 1 fps. This initial aircraft shown has a total of twelve ↓ and represents the aircraft descending at 12 fps.

Referring now to FIG. 2b there is shown the transport category aircraft 1 as it executes a flare procedure. The nose of the aircraft is brought to a higher angle of attack which brings the aircraft closer to a stall configuration, which helps reduce aircraft 1 horizontal speed as well as the rate of vertical descent. The flare procedure is executed to quickly reduce the aircraft vertical descent velocity. Upon execution of the flare procedure the aircraft now shows a total of four ↓ and represents the aircraft's reduced vertical velocity and descending towards the ground at 4 fps.

Referring now to FIG. 2c there is shown the transport category aircraft 1 as it comes into initial contact with the ground 3. After successfully completing the flare procedure (as shown in FIG. 2b), aircraft 1 has reduced its horizontal velocity as well as the vertical descent velocity and in this example, gently comes into contact with the ground 3 at a vertical descent rate of 2 fps. Though the aircraft has come into initial contact with the ground, until the total weight of the aircraft has become totally supported by the compressing landing gear 9; the VVG of aircraft 1 will continue to decrease until such time as the vertical velocity becomes zero, being at some point after the aircraft has come into initial contact with the ground.

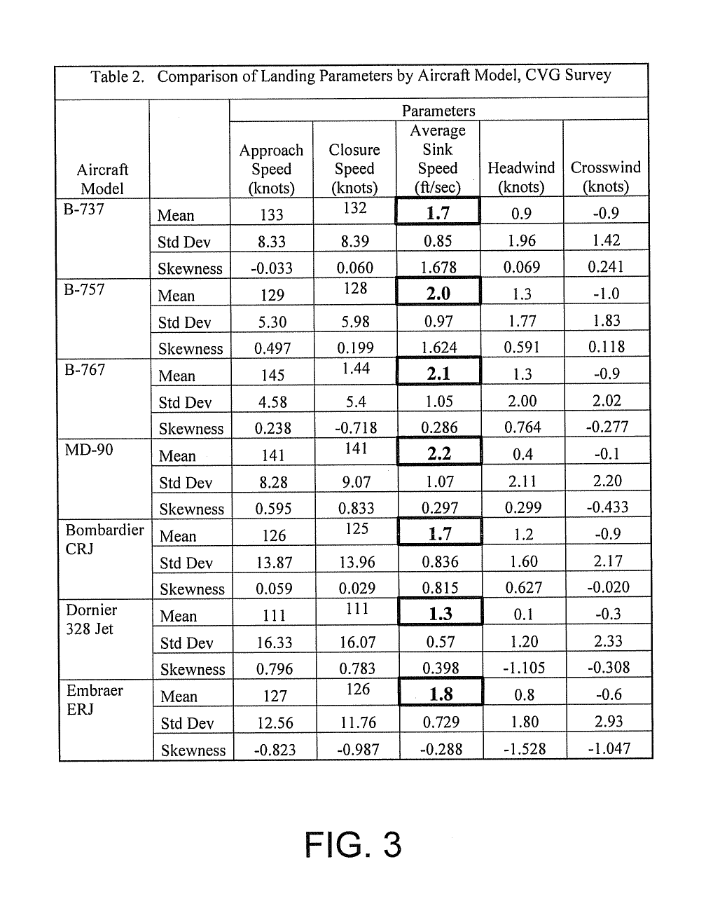

Referring now to FIG. 3, there is shown Table 2, page 10, from DOT/FAA/AR-08/12 VIDEO LANDING PARAMETER SURVEYS—CINCINNATI/NORTHERN KENTUCKY AND ATLANTIC CITY INTERNATION AIRPORTS—Comparison of Landing Parameters by Aircraft Model, CVG Survey.

Beginning in 1993, the FAA William F. Hughes Technical Center initiated a series of surveys which measured aircraft landing parameters at various airports around the world. There were a total of ten surveys completed: Atlantic City 1993, John F. Kennedy International 1997, Washington National 1999, Honolulu International 2001, London City Airport 2004, Philadelphia International 2004, Atlantic City International 2004, London Heathrow 2007, Atlantic City International 2008, and Cincinnati Airport 2008. Data shown herein is from the most recent 2008 survey data recorded at the Cincinnati Airport and shows various aircraft average sink-speeds with the “Mean” (shown in bold) ranging from 1.3 fps to 2.2 fps.

The average range near 2 fps is far lower than the Regulatory Authorities 10 fps assumptions, as defined in Part 25 aircraft design criteria. The “Average Sink Speed” parameters reveal larger aircraft have tendencies to land at slightly higher sink speed than smaller aircraft. But regardless of the size of the aircraft, no aircraft in the survey showed an average sink speed near a range of 6 fps (which allows aircraft to land up to the much higher maximum take-off weight) or the assumed 10 fps limitation used for determining aircraft maximum landing weight.

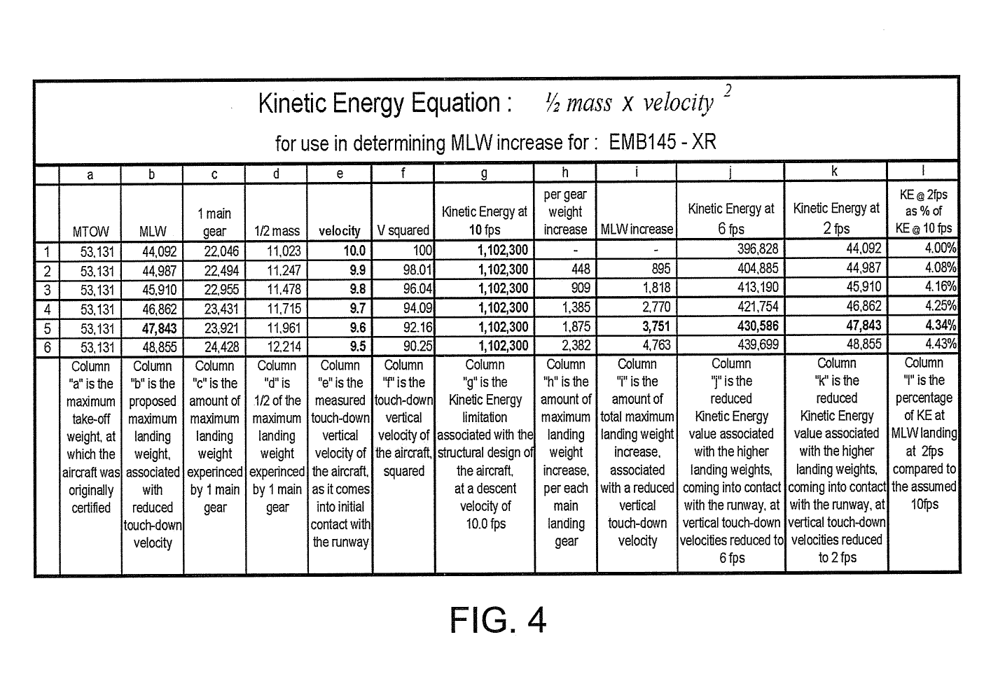

Referring now to FIG. 4 there is shown a table illustrating the relationship between aircraft vertical velocity at initial contact with the ground “VVG”, as compared to aircraft landing weight. Aircraft landing weight and the vertical velocity at which that weight comes into initial contact with the ground, are the primary factors for the Part 25 aircraft design criteria and are used to determine the Kinetic Energy at touchdown. A typical expression of Kinetic Energy “KE” is “one-half the mass times the velocity squared”:

KE=½ Mass×Velocity²

The calculations contained herein are that for a typical Part 25 transport category aircraft. Used as an example is the Brazilian manufactured Embraer EMB 145-XR. The design maximum take-off weight “MTOW” for the EMB 145-XR is 53,131 pounds and is indicated in Column a, Row 1. The MTOW value remains unchanged in Column a, throughout Rows 1-6.

In further illustration of this matrix, and defining the values horizontally across Columns b through g, within Row 1 are as follows:

Column b is the “original” design landing weight limitation of the EMB 145-XR aircraft, and is 44,092 pounds. Column c is 22,046 pounds, which is ½ of the amount of Column b which represents the weight (or mass) supported by one of the two main landing gear, which absorb the aircraft's initial landing impact. Column d is 11,023 pounds, which is ½ of the amount of Column c, to correspond to the “½ Mass” segment of the KE equation. Column e is the “assumed vertical velocity” of the aircraft, as it comes into initial contact with the ground “VVG.” As a starting point for the calculations of this matrix, the Column e, Row 1 amount is equal to the Part 25 aircraft limit descent assumption of 10 fps. Column f is the squared amount of an assumed but subsequently “measured” vertical velocity of the respective velocity value of Column e. Multiplying the “½ Mass” value shown in Row 1 Column d, times the velocity squared value in Row 1 Column f, generates Row 1 Column g; being a Kinetic Energy value of 1,102,300. This Kinetic Energy value in Column g represents the aircraft manufacturer's originally designed structural integrity, associated with the EMB 145-XR aircraft, based upon the 10 fps assumption and the value associated with the determination of the aircraft MLW limitation shown in Row 1 Column b.

Looking down Column g, through Rows 2-6, the 1,102,300 Kinetic Energy value shall remain unchanged. Keeping the 1,102,300 value a “constant” throughout the lower Rows of the matrix insures the manufacturer's original design structural integrity will not be exceeded. Maintaining the 1,102,300 Column g value and reversing through the Kinetic Energy equation, using lower vertical velocity values within Column e Rows 2-6, allows for determination and illustration of the increased aircraft landing weights, as shown in Column b, Rows 2-6, associated with the lower VVG assumptions.

In continuation as a further example: across Row 5, wherein vertical velocity in Column e is reduced to 9.6 fps, (and averting any exceedance of the 1,102,300 KE value shown in Column g), the MLW limitation is now determined by solving for mass in the equation: 1,102,300=½ (mass)×(9.6)². The mass (MLW) is now 47,843, which is an increase in the aircraft design landing weight of 3,751 pounds, as shown in Column i.

With the installation and use of apparatus which measure the compression rate of the aircraft landing gear, and the methods and strategies of this invention, Column e being the VVG will now become a “measured” vertical velocity. The elimination of having to rely on assumptions of VVG, can now be replaced with measured VVG.

Column h, Rows 2-6 are the values for additional amounts of landing weight, being associated with respective reduced vertical velocity, for a single landing gear strut; and Column i, Rows 2-6 are those respective values multiplied by two, accounting for both main landing gear, for the total increase in landing weight, associated with reduced vertical velocity for the entire aircraft. As shown in Columns e and i, as the assumed touchdown vertical velocity decreases slightly from 10 fps to 9.9, the MLW increases by 895 pounds. As the touchdown vertical velocity decreases even more, the MLW increases (e.g. for 9.5 fps, MLW increases by 4,763 pounds).

Thus reducing the assumed, but now measured touchdown vertical velocity allows more weight (passengers, cargo, fuel, etc.) to be carried by the aircraft.

Column j Rows 1-6, are the calculations of the respective Kinetic Energy values associated with even further reduced descent velocity (for example: at a constant 6 fps) when calculated by the respective increasing landing weights values of Column b, Rows 1-6. Considering all of the values in Column j are below 440,000 and the original design structural integrity of the EMB 145-XR is a value of 1,102,300, there is strong justification that landing events at velocities below 6 fps do not come near to approaching the original design structural integrity of the aircraft. This reinforces the justification that requirement of “post landing” aircraft inspections with measured VVG values of 6 fps or greater offer a Superior Level of Safety than landing events without VVG measurement or detection, which might possibly allow a damage aircraft to remain in operation without inspection.

The table illustrates the striking evidence that reductions in vertical velocity, as a function of the velocity value squared, sharply reduces the Kinetic Energy values. Column k equates to the Kinetic Energy values associated with a much lower 2 fps assumption, that being shown in Column 1, and is less than 4.50% of the original aircraft structural design values.

Regulatory Authorities require only the demonstration of an Equivalent Level of Safety, when asking for modifications in certification rules. Use of apparatus and methods of this invention offer a Superior Level of Safety.

By means of the use of an “inverse argument” one can best illustrate the reasoning of this Superior Level of Safety, with a hypothetical situation: suppose Regulatory Authorities have previously allowed relief in the design criteria VVG assumption from 10 fps to 9.6 fps, with the requirement that all landing events be measured; the Regulatory Authorities would surely become comfortable that aircraft landing events would be no longer subject to mere assumptions, but assured by the fact that all subsequent landing events were verified with actual measured VVG data. Supposing the Regulatory Authorities were then given the opportunity to undo the design criteria relief, back to 10 fps, with the condition that no further landing events would be verified by measured data. The Regulatory Authorities would assuredly deny any such request to remove equipment from the aircraft that provides safety information, to then rely only on mere assumptions. This is the primary argument for justification that aircraft design criteria assumptions of 9.6 fps with “measured” VVG data, is an Equivalent Level of Safety, to that of 10 fps assumptions, with “no measured” VVG data.

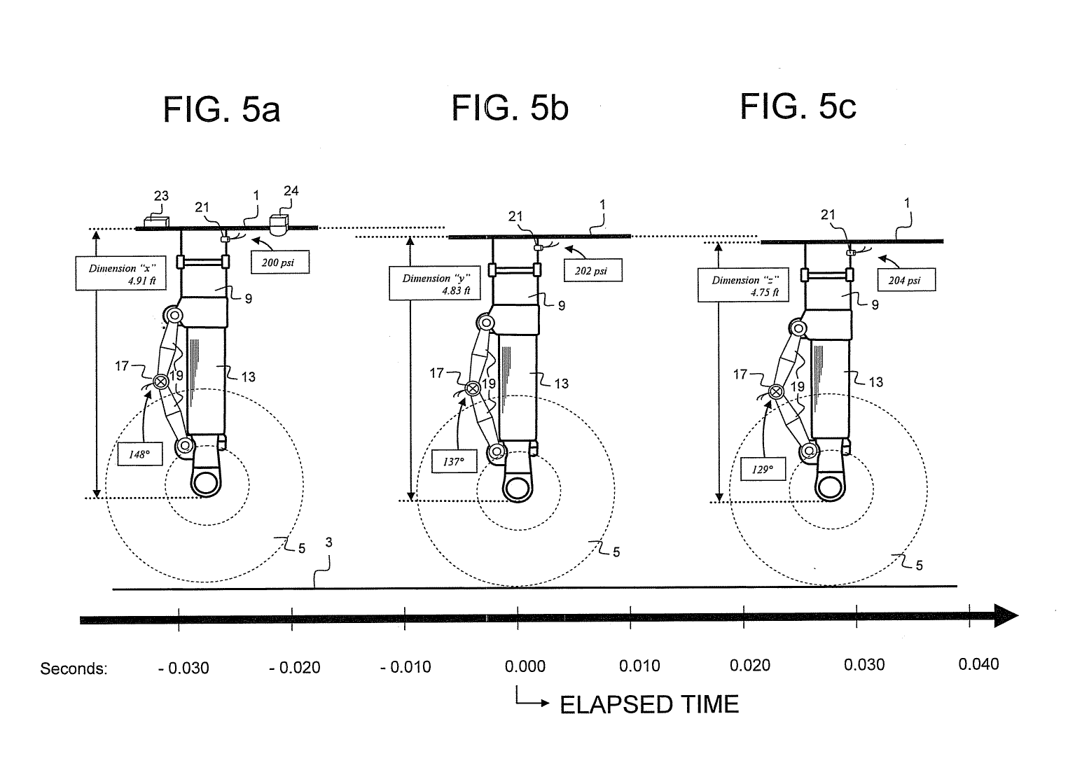

Referring now to FIGS. 5a, 5b and 5c; there are shown two separate, but potentially complimentary, versions of the apparatus of the invention for justifying an increase in aircraft MLW, which measure the compression rate of a “vertical, telescopic” landing gear design. Additionally, an illustration of Software Program “Alpha”, where initial touch-down determination and landing gear compression is measured to determine when the aircraft has come into initial contact with the ground; and illustration of Software Program “Beta”, where determination of landing gear compression, measured against elapsed time is used to determine aircraft vertical velocity at initial contact with the ground, being the aircraft “VVG”.

Illustrated across the bottom through FIGS. 5a, 5b and 5c is an arrow extending from left to right. This arrow represents ELAPSED TIME. The vertical lines on the arrow divide ELAPSED TIME into increments of 10/1,000^{th} of a second. ELAPSED TIME begins at the initial contact with the ground and extends to the completion of a landing event. Prior to the initial contact with the ground, ELAPSED TIME is illustrated in negative numbers, counting down to initial contact with the ground.

Shown by FIGS. 5a, 5b and 5c is a sequence of views of a “vertical telescopic” aircraft main landing gear 9, as would be deployed from an aircraft hull 1. When the landing gear 9 is deployed from within aircraft hull 1 and locked into place, prior to the landing event; the body of landing gear 9 maintains a fixed position in relation to aircraft hull 1. The working pressure within landing gear 9 is continually monitored and measured by a pressure sensor 21. Landing gear strut 9 incorporates a telescopic piston 13. The rate of telescopic compression of landing gear 9 is proportional to the reduced internal volume as piston 13 compresses into strut 9. Internal strut volume is proportional to internal strut pressure. Increased strut pressure is proportional to reduced strut volume. Monitoring increases in strut 9 internal pressure by pressure sensor 21 as compared to elapsed time, allows for the monitoring and measuring the “compression rate” of strut 9. The rate of compression of strut 9 is the collapse rate of strut 9. The collapse rate of strut 9, corrected as to vertical, is the VVG—vertical velocity of the aircraft, as it comes into initial contact with the ground. The rate of telescopic compression of the landing gear strut 9 is also measured by the monitoring the changes in angle of the landing gear torque-link mechanism 19. The torque-link 19 is sometimes referred to as a scissor-link and functions to prevent the rotation of piston 13 within landing gear strut 9. A rotation sensor 17 is mounted at the hinge-point of torque-link 19, to measure the changing angles of the opposing arms of torque-link 19, as piston 13 compresses within strut 9. Changes in the angle at the hinge-point of the opposing arms of torque-link 19, measured by rotation sensor 17, are proportional to the rate of compression of piston 13 within landing gear strut 9.

FIG. 5a shows aircraft 1 with a deployed main landing gear 9, which includes a telescopic piston 13, and rubber tire 5 (tire 5 shown as dashed lines). Landing gear 9 is above the ground 3, while the aircraft is still in flight, with no weight being supported by landing gear 9. Landing gear 9 contains internally both a non-compressible fluid (such as hydraulic oil) and a compressible gas (such as nitrogen). As telescopic landing gear 9 compresses at initial contact with the ground 3, the volume and dimensional length of landing gear 9, with telescopic piston 13, will change. The internal pressure of the compressible nitrogen gas within telescopic landing gear 9 will increase in direct proportion to the reduced gas volume within landing gear 9. This is attributed to Boyle's Gas Law, “pressure has a proportional relationship to volume.”

For landing gear 9 to function at its maximum effectiveness, it is important that telescopic piston 13 be extended to its full telescopic limits, prior to the aircraft landing. While aircraft 1 is above the ground 3 and the landing gear 9 is supporting no weight, landing gear 9 maintains what is commonly referred to as a “pre-charge pressure.” This pre-charge pressure is a relatively low pressure, but of a sufficient amount of pressure to force the telescopic feature of strut piston 13 to maintain its full extension limits, while bearing no weight. With strut piston 13 at full extension, landing gear 9 is capable of absorbing the maximum design landing load limits for aircraft 1.

As tire 5 comes into contact with the ground 3 (FIG. 5b), the pressure within landing gear 9 will increase in direct proportion to the decreased internal volume of landing gear 9. As an example: shown in FIG. 5a, the pre-charge pressure within telescopic landing gear 9 is 200 psi. (As additional reference: when a fully loaded aircraft is resting on its plural landing gear, and the landing gear are at near full compression, the loads on a typical main landing gear can generate internal pressure up to 1,800 psi)

FIG. 5a shows the landing gear 9 before initial touchdown with the ground 3, with the fully extended piston 13 illustrated by a Dimension “x” measured at 4.91 feet, with a pre-charge pressure of 200 psi, and a torque-link 19 angle of 148° as measured by rotation sensor 17. Dimension “x” in this example is the distance measured from the lower portion of the aircraft hull 1 to the lowest point on strut piston 13. Alternate locations can be used for determining the Dimension “x” measurement, as long as the opposing locations are selected from the fixed structure of landing gear 9 or aircraft 1, and compared to a location on the opposing portion of piston 13, which telescopically travels in relation to the fixed components.

FIG. 5b shows the landing gear 9 at initial touchdown, with a partially compressed piston 13, illustrated by a Dimension “y” measured at 4.83 feet, with a slightly higher pressure of 202 psi, and a torque-link 19 angle as measured by rotation sensor 17, of 137°. Software Program “Alpha” recognizes any increase in strut pressure from the 200 psi pre-charge pressure, will identify the aircraft landing gear 9 has come into initial contact with the ground 3. Software Program “Gamma” recognizes any decrease in torque-link angle from the 148° associated with full extension of the telescopic strut 9, will identify the aircraft landing gear 9 has come into initial contact with the ground 3.

FIG. 5c shows the landing gear 9 compressing further after initial touchdown with ground 3, with a further compressed piston 13, illustrated by a Dimension “z” measured at 4.75 feet, with an even higher pressure of 204 psi, and a torque-link 19 angle as measured by rotation sensor 17, of 129°. Software Program “Delta” recognizes the increase in strut pressure from the 200 psi pre-charge pressure to 202 psi, with further increase in strut pressure to 204 psi, as measured against elapsed time, and allows for the determination of VVG, at this respective landing gear strut 9. Software Program “Delta” recognizes the decrease in torque-link angle from the 148° associated with full extension of the telescopic strut 9 to 137°, with further decrease in torque-link angle to 129°, as measured against elapsed time, and allows for the determination of VVG, at this respective landing gear strut 9.

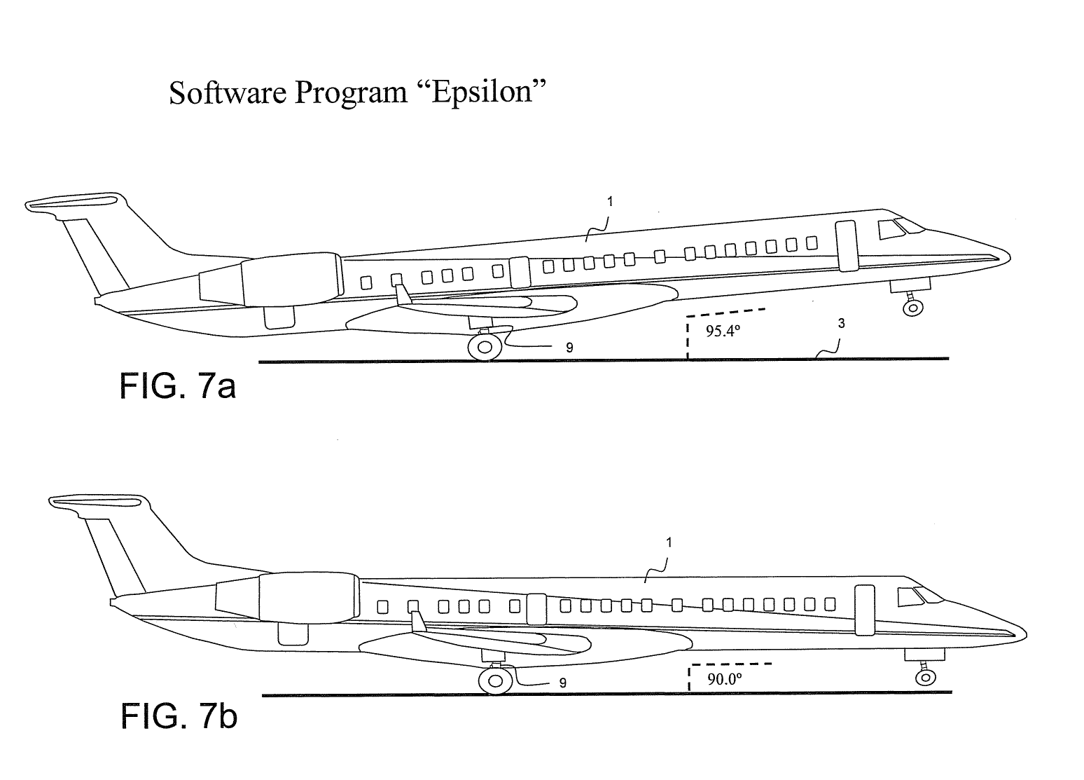

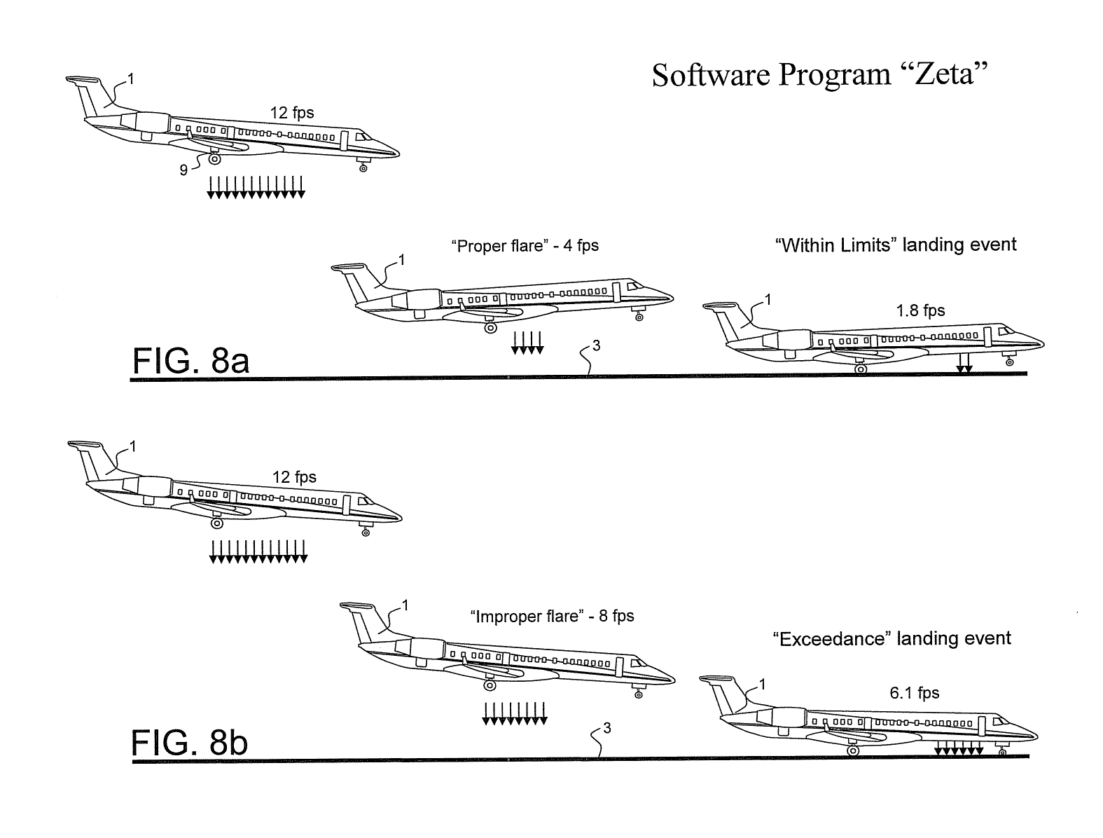

ELAPSED TIME is monitored by an internal clock, located within the system's computer 25 (see FIG. 8). Attached to aircraft hull 1 is inclinometer 23. Inclinometer 23 measures aircraft hull 1 angle, in particular aircraft 1 relationship to horizontal, during the landing event. As tire 5 of landing gear 9 comes into contact with the ground 3; if aircraft hull 1 is not horizontal, having landing gear 9 in a non-vertical position; measurements from inclinometer 23 are used to correct any non-horizontal angle of aircraft 1, and correct the calculations of the compression rate of the non-vertical landing gear 9, to that of landing gear 9 being vertical (more fully described in FIGS. 7a and 7b).

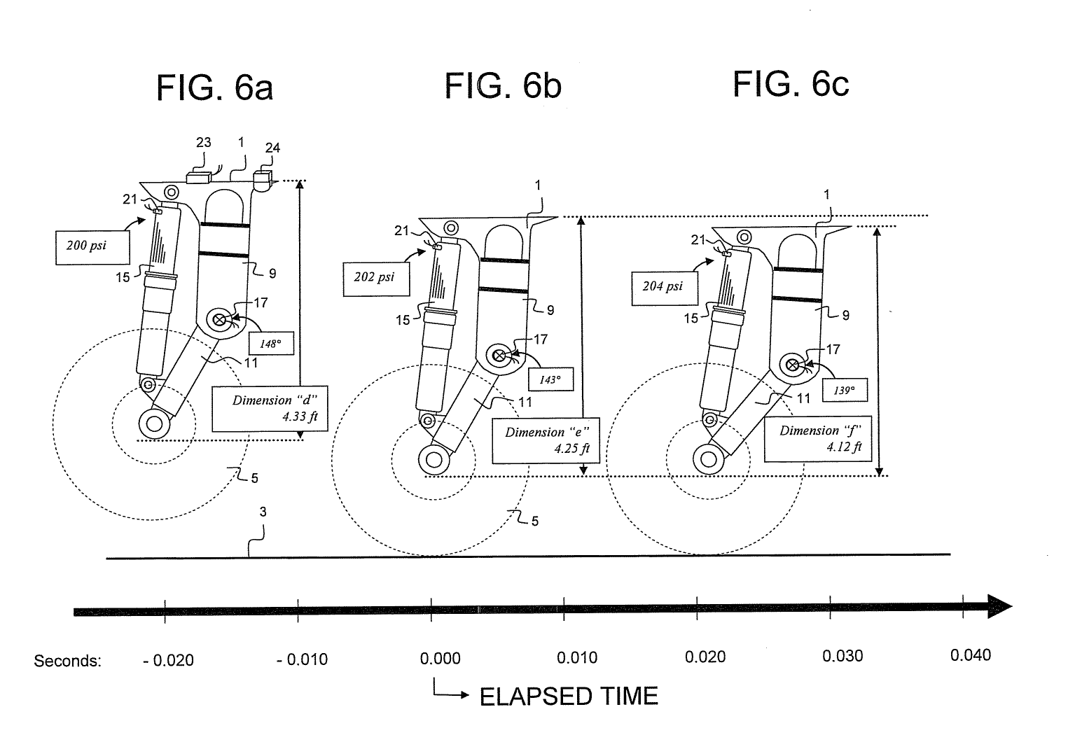

Shown by FIGS. 6a, 6b and 6c is an alternate design for aircraft landing gear where the landing gear 9 incorporates a trailing arm 11. Aircraft 1 landing loads are absorbed by the compression of shock absorber 15. As shown throughout FIGS. 6a, 6b and 6c the pressure within shock absorber 15 is monitored by pressure sensor 21 and the rotating components are no longer the torque-link 19 as shown in FIG. 5a-c, but rather the hinge-point is at the connection of strut 9 with trailing arm 11. A rotation sensor 17 is attached to the hinge-point of trailing arm 11, and as described in FIG. 5 a-c above measures rotation. Pressure within shock absorber 15 is measured by pressure sensor 21. The pressure within shock absorber 15 is proportional to the volume of shock absorber 15. The volume of shock absorber 15 is proportional to the telescopic extension of shock absorber 15. The telescopic extension of shock absorber 15 is proportional to the distance as measured by Dimension “d”. Additionally, angle changes of trailing arm 11, as measured by rotation sensor 17 and are proportional to the distance as measured by Dimension “d”. A mathematical algorithm associated with each different aircraft landing gear variations, as to the size and stroke of the compressible landing gear components is developed to convert both measured strut pressure changes and measure rotating element angle changes, to calculate the variations in distance from Dimension “d” to Dimension “e”, then further to Dimension “f” of the various aircraft types.

The examples explained herein will allow for the identification of the aircraft VVG at initial contact with the ground, which is further used in conjunction with additional methods of this invention as the justification basis in allowance for an increase in the aircraft MLW.

The vertical velocity at initial contact can be determined using the methods described in this inventor's earlier U.S. Pat. No. 7,274,310. Such methods include measuring the extension of the strut over elapsed time or measuring the rotation of a linkage strut over elapsed time. Furthermore, acceleration measurements can be used to determine vertical velocity. For example, the acceleration of the aircraft hull, over elapsed time can be used to determine vertical velocity at initial contact.

Some compensation may be needed to increase the accuracy of the measurements. For example, “initial contact” as used herein may be the first contact of the landing gear with the ground or it may be a subsequent contact, such as may be encountered after a bounce. Thus, one type of compensation would be to determine the contact of interest. Such contact would typically be the hardest contact.

Another type of correction has to do with inclination of the airframe to horizontal. Referring now to FIGS. 7a and 7b there is shown an illustration of Software Program Epsilon—Aircraft Hull Angle Compensation, which compensates for the aircraft hull 1 not being horizontal and level, as the aircraft starts and continues through the landing event. Shown in FIG. 7b is horizontal aircraft hull 1, with attached perpendicular landing gear 9, where perpendicular landing gear 9 has a measured angle (measured by the inclinometer 23 shown in FIG. 5a) of 90.0° to that of the ground 3. The aircraft 1 with perpendicular landing gear 9 shown in FIG. 7a has a measured angle of 95.4° to that of the ground 3.

The angle of landing gear strut body 9 in relation to this example of aircraft hull 1 is fixed perpendicular and does not change (as shown in FIGS. 5a, 5b and 5c). Furthermore, while the aircraft is in flight and commences to flare the aircraft hull 1 (shown in FIG. 2b) for the landing event, aircraft hull 1 will change angle prior to and during the landing event. Adjustments for the changing angle of aircraft hull 1, to that of what the aircraft hull 1 would be when parallel to ground 3 (see FIG. 7b) are made to correct for differences in landing gear compression determinations, as compared to strut body 9 (see FIG. 5c) when vertical/perpendicular to the ground 3. In the example shown, the correction from 95.4° non-vertical landing gear 9 (FIG. 7a), to that of the 90.0° vertical landing gear 9 (FIG. 7b) will be an adjustment of 5.4°. Mathematical algorithms make adjustments to correct the landing gear rate of compression, to that equivalent of landing gear 9 being vertical and aircraft hull 1 being in a level position, parallel to ground 3, so as to determine the “true” vertical value of descent velocity.

Referring now to FIGS. 8a and 8b there is shown an illustration of Software Program Zeta—Aircraft Vertical Velocity at initial contact with the Ground “VVG”, and Exceedance Determination. Software Program Zeta measures the aircraft VVG on all landing events. The software program determines the descent velocity of the aircraft at initial contact with the ground and also determines if the descent velocity exceeds a predetermined threshold, and the software program provides and indication to the flight crew and/or maintenance personnel if the threshold is exceeded.

Shown in FIG. 8a is a typical “transport category” aircraft 1 maintaining a landing descent angle as it approaches the ground 3. Deployed from the lower body of aircraft 1, are main landing gear 9. Main landing gear 9 absorbs the initial landing force as aircraft 1 comes into initial contact with the ground 3. Each of the downward pointing arrows (↓) represents the equivalent of 1 fps. As shown in FIG. 8a and working from left to right, the initial aircraft 1 shown has a total of twelve ↓ and represents the aircraft descending at 12 fps. Upon execution of the flare procedure the aircraft then shows a total of four ↓ and represents the aircraft's reduced vertical velocity to 4 fps as it nears initial contact with the ground 3. As aircraft 1 comes into initial contact with the ground 3, the aircraft then shows a total of two ↓ and represents the aircraft's reduced vertical velocity (being the VVG), and now coming into contact with the ground at 1.8 fps. Though the aircraft 1 has come into initial contact with the ground 3, until the total weight of the aircraft 1 has become totally supported by the compressing landing gear 9, the VVG of aircraft 1 will continue to decrease until such time as the vertical velocity becomes zero, being at some point after the aircraft 1 has come into initial contact with the ground 3.

In this example landing events with measured VVG at 6.0 fps or less, are considered to be a “within limits” landing event. If a measured landing event has a VVG in excess 6.0 fps it is identified as an “exceedance.”

As aircraft 1 nears runway 3, and a flare procedure is not executed properly (as shown by the aircraft in FIG. 8b) a landing event of 6.1 fps or higher may occur that is not within acceptable limits. The determined threshold for exceedance limitation is subject to change to a particular airline operational preference. As an example: a respective airline may wish to lower the exceedance limit threshold to a value of 5.3 fps. Therefore Software Program Zeta is designed with the ability to change the values designated for an exceedance.

2 fps is a typical VVG for most aircraft 1 landing events (see FAA landing data, FIG. 3). In today's airline operations, the VVG of aircraft 1 is not measured, thus the text of the design criteria using the word assumption. Therefore, the assumption used by aviation Regulatory Authorities must allow for a very large margin of safety. The assumption used to maintain this margin for safety for aviation Regulatory Authorities is the 10 fps assumption of a limit descent velocity.

Strut compression is determined by either measured rotation of hinged elements of the strut, or by measured pressure increases within the landing gear, and strut compression is measured throughout the landing event. The landing event is from just before the strut has made contact with the ground, when the wings generate lift to support the aircraft off of the ground, to the strut in contact with the ground and the wings no longer generating lift, so that the full weight of the aircraft is applied to the struts. Typically, the highest descent velocity will occur upon initial contact of the strut with the ground. However, due to landing vagaries, the highest descent velocity may occur sometime after initial contact of the strut with the ground. Therefore, preferably, strut compression measurements are taken throughout the landing event so that the highest descent velocity can be found if not at the beginning of the event. As used herein, “initial contact” means the contact of interest in determining descent velocity, whether that contact is truly the first contact or a subsequent contact, such as from a bounce of the aircraft.

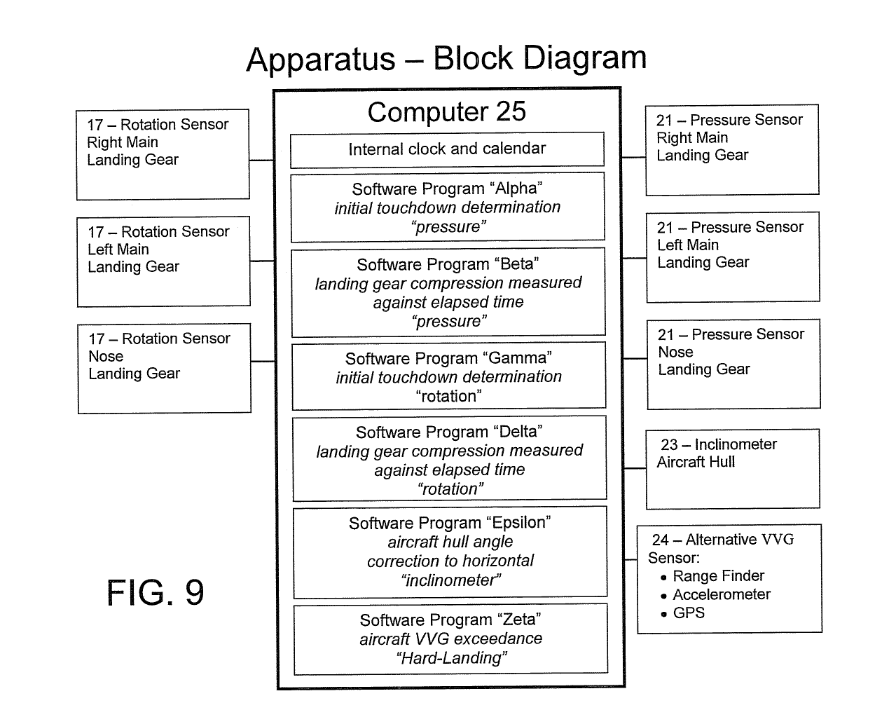

Referring now to FIG. 9, there is shown a block diagram illustrating computer 25 being part of the apparatus of the invention, where multiple inputs from (respective nose, left-main and right-main landing gear) rotation sensors 17 and strut pressure sensors 21 as sources of data inputs to computer 25. Aircraft hull inclinometer 23, which can be located on any horizontal portion of the aircraft 1, or located directly onto the vertical landing gear strut (see FIG. 5a) also has an input to computer 25. The computer 25 output determinations and information are transmitted via a series of flashing patterns to a LED diode located on the face of computer 25. Various changes of aircraft hull angle, measured by inclinometer 23 are inputs to onboard computer 25 prior to initial contact with the ground, as well as angle changes as the landing gear makes initial contact with the ground. Computer 25 is equipped with an internal clock and calendar to document the time and date of received and stored data. Computer 25 has multiple software packages which include: Software Program “Alpha”—initial touch-down determination and landing gear compression measured by increases in strut pressure, to determine that the aircraft has come into initial contact with the ground; Software Program “Beta”—landing gear compression measured by pressure increases compared to elapsed time to determine aircraft VVG; Software Program “Gamma”—initial touch-down determination and landing gear compression measured by decreases in torque-link angle, to determine that the aircraft has come into initial contact with the ground; Software Program “Delta”—landing gear compression measured by pressure further decreases in torque-link angle, as compared to elapsed time, to determine aircraft VVG; Software Program “Epsilon”—Aircraft Approach Angle Compensation, which uses inclinometer data to correct vertical velocity determinations at initial contact with the ground, where the aircraft hull is not horizontal and level will the ground. Software Program “Zeta”— Aircraft Vertical Velocity at initial contact with the Ground “VVG”, threshold and exceedance, determination of Hard Landing.

Although the VVG of an aircraft is discussed as being measured by pressure sensors or rotation sensors on a landing gear strut, there are other ways and other sensors 24 (see FIG. 6) to measure VVG. For example, a rangefinder 24 can be used. The rangefinder is mounted to the aircraft hull and is directed down to the ground. The rangefinder can be a laser rangefinder or an acoustic rangefinder. As the aircraft approaches the ground during a landing event, the distance or range between the rangefinder and the ground is measured. Contact of the landing gear with the ground is detected by the range becoming constant, within a variation, or by the range becoming a predetermined distance, or a combination of both. The VVG is determined by the change in measured distance or range, over elapsed time.

Another example of a sensor 24 used to measure VVG is an accelerometer. As the aircraft descends, any changes in acceleration are sensed by the accelerometer. The acceleration of the aircraft during descent is measured and recorded. The initial contact of the landing gear with the ground is sensed and determined by the sudden change in acceleration. The VVG is determined from the measure of acceleration at initial contact of the landing gear with the ground.

Still another example of the sensor 24 used to measure VVG is a global positioning system (GPS) receiver. The GPS receiver can determine altitude. If the altitude of the runway is known, then the distance between the GPS receiver and the ground can be determined. This distance is determined and measured as the aircraft descends toward ground. The VVG can be determined when the landing gear of the aircraft makes initial contact with the ground. The GPS receiver data can be used to determine initial contact of the aircraft with ground by determining when the aircraft reaches the proper altitude for the landing gear it will be touching the ground. Alternatively, the altitude data becomes constant when the aircraft touches the ground.

One or more of these devices, pressure sensor, rotation sensor, accelerometer, rangefinder, and GPS receiver can be used in combination. For example, pressure sensors in the struts can be used in conjunction with rangefinders, accelerometers, and/or GPS receivers to determine when the landing gear makes initial contact with the ground.

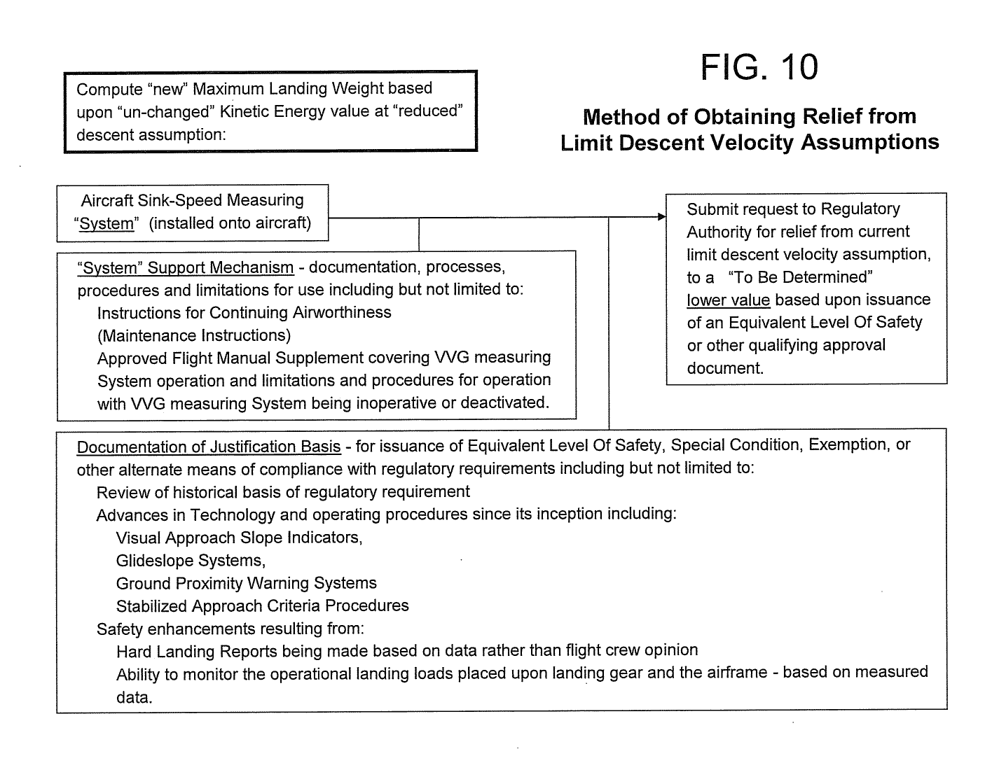

Referring now to FIG. 10, there is shown a process design flow chart for a Method of Obtaining Relief from Limit Descent Velocity Assumptions by the Regulatory Authorities. Relief from limit descent velocity assumptions, from the regulatory authorities is required for the subsequent operation of the aircraft at a second higher maximum landing weight limitation. Upon the computation of a new increased Max-Landing Weight limitation, predicated on a reduction of the assumed and subsequently measured descent velocity, and the apparatus to measure and verify “VVG” on all subsequent landing events, a system support mechanism is created to document the processes, procedures and limitations for the use of the apparatus and methods of this of this invention, that Regulatory Authorities are assured an Equivalent Level of Safety is maintained. These include, but are not limited to creating and maintaining Instructions for Continued Airworthiness, addition of an Approved Flight Manual Supplement covering this new VVG measuring system operation, limitations and procedures, as well as operational adjustments in the event the VVG measurement system is inoperable.

Also required is a complete “Documentation of the Justification Basis” for the issuance of an Equivalent Level of Safety, Special Condition, Exemption, or other alternate means of regulatory compliance. These factors include a review of the historical basis of regulatory requirement, along with advancement in technology and operating procedures since the inception of the 10 fps rule. Some of these advancements include the development of new systems and procedures that aid pilots in executing proper landings with systems such as Visual Approach Slope Indicators, Glideslope Aid Systems, Ground Proximity Warning Systems, and improved Stabilized Landing Approach Criteria and Procedures.

Safety will be increased by the subsequently implemented practice of aircraft Hard Landing Reports being made on measured data, rather than aircraft flight crew opinion. Safety will also be increased with subsequent monitoring of aircraft operational landing loads, at each respective landing gear, as opposed to waiting until a scheduled maintenance cycle event, to then find minor or major damage, which would have occurred earlier.

These supporting materials and procedures are submitted to the Regulatory Authority as justification for the Regulatory Authority's acknowledgement and approval to allow design criteria assumptions to be reduced to a value lower than 10 fps, with this demonstration of an Equivalent Level of Safety, or other qualifying document.

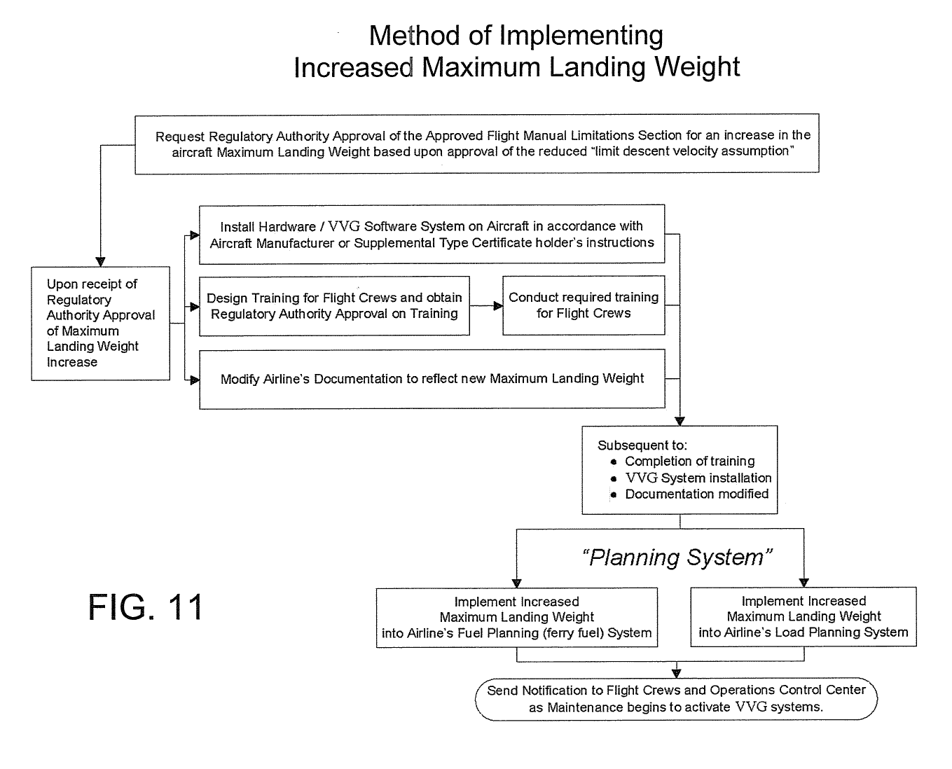

Referring now to FIG. 11, there is shown a process design flow chart for a Method of Implementing Increased Maximum Landing Weight. This additional system support mechanism is created to document the processes, procedures and limitations for the use of the apparatus and methods of this invention, that Regulatory Authorities are assured an Equivalent Level of Safety is maintained. Request is made of the Regulatory Authority to approve modifications to the aircraft's Approved Flight Manual Limitations section regarding the increase in aircraft MLW limitation. Upon such Flight Manual modification approval, the completion of the installation of the VVG measuring system onto the aircraft, in accordance with respective Supplemental Type Certificate installation requirements; the design of newly modified flight training programs for flight crew and implement such training programs for the use and understanding of the new VVG system are completed. The airline which operates the aircraft with the increased MLW limitation will modify its documentation for each respective aircraft equipped with the VVG measuring system. The airline operating aircraft with the increased MLW will amend their “load planning programs”. When these programs and processes are complete, notification can be made to flight crews and the airline's Operational Control Center, as Maintenance Control activates the VVG systems.

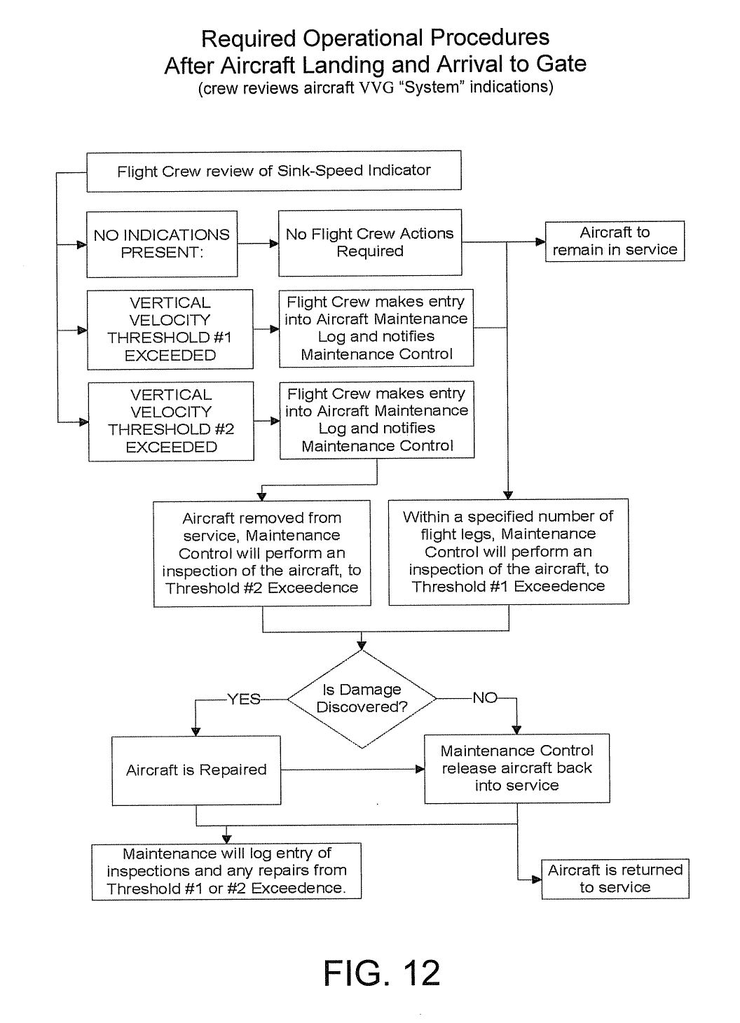

Referring now to FIG. 12, there is shown a process design flow chart, for required post-landing actions, to be followed by aircraft Flight Crew and Maintenance Control personnel, upon observance of measurement indications from VVG measuring System. This additional system support mechanism is created to document the processes, procedures and limitations for the use of the apparatus and methods of this invention, so that Regulatory Authorities are assured an Equivalent Level of Safety is maintained. In the preferred embodiment of this invention the VVG measuring system will display any aircraft VVG “Threshold” exceedance within three defined ranges. The first range of measurements will be those of less than 6 fps. If the aircraft lands at a VVG less than 6 fps, there will be no indication of a VVG Threshold #1 exceedance, but merely an indication that the system is functioning properly and accurately measuring VVG. Such case requires no flight crew actions and the aircraft may remain in service. If the aircraft lands exceeding 6 fps, but less than 8 fps a VVG Threshold #1 exceedance will be indicated. Still, to offer a “Superior Level of Safety”, upon a VVG Threshold #1 exceedance, the flight crew will make a notation of the incident into the aircraft log-book and notify Maintenance Control of the Threshold #1 exceedance. The aircraft will remain in service throughout the remainder of that day, but Airline Maintenance Control will perform a Threshold #1 inspection of the aircraft at the end of that day's service. This VVG identification and aircraft inspection process is not a requirement of the current aircraft regulations and implementing such a program offers a Superior Level of Safety. If no damage is found to the aircraft, the aircraft may return to service. If damage is found, the damage will be repaired and additional actions taken to lower the Threshold #1 exceedance parameters, though landing events within the 6 fps to 8 fps range should not damage the aircraft, due to original 10 fps design criteria, even though such damage was found. This added ability to lower the VVG value, that prompts the Threshold #1 inspection, will offer a Superior Level of Safety. Once the damage has been repaired, the aircraft can then be returned to service.

If the aircraft lands and VVG exceeds a predetermined value (in this example greater than 8 fps) there will be an indication of a Threshold #2 exceedance. With the occurrence of a Threshold #2 exceedance, the aircraft must be immediately removed from service. Maintenance Control will perform a more intense Threshold #2 inspection of the aircraft for damage. If no damage is found to the aircraft, the aircraft may return to service. If damage is found, the damage will be repaired and additional actions taken to lower the Threshold #2 exceedance parameters, though landing events less than 8 fps should not damage the aircraft, due to original 10 fps design criteria, even though such damage was found. This added ability will offer a Superior Level of Safety. Once the damage has been repaired, the aircraft can then be returned to service.

Thus, an aircraft can be operated at a different maximum landing weight. The aircraft has a first maximum landing weight based upon a first assumed maximum descent velocity. Vertical velocities of the aircraft at initial contact with the ground are obtained. These can be obtained by measurements from the aircraft itself, or aircraft of the same model, or from previously recorded measurements of the aircraft or aircraft of the same model. Vertical velocity data obtained from one particular aircraft or airplane can of course be used for aircraft or airplanes of the same model (such as Boeing 767). Using the vertical velocity data, the aircraft is operated at a second assumed maximum landing velocity. While so operating the aircraft, the vertical velocities of the aircraft at initial contact with the ground are measured and recorded. The aircraft is operated at a second maximum landing weight based upon the second assumed maximum descent velocity. Typically, the second maximum landing weight is greater than the first maximum landing weight. The first maximum descent velocity is typically 10 fps. The second maximum descent velocity can be less than 10 fps, such as 9.8 fps or 9.6 fps. During operation, if the measured descent velocity at initial contact with the ground exceeds a predetermined threshold, typically set at less than the second assumed maximum descent velocity, then the aircraft is inspected.

Described within this invention are methods and strategies developed; in which the whole are now greater than the sum of its parts. Each of the sub-practices of this invention are elements which build upon each other, and strengthen the foundation of justification for the realization that the aircraft design criteria regulations dating back to 1945, have worked well for decades; but the development of new technologies, procedures and the careful implementation and monitoring of such practices offer justification through a finding of an Equivalent Level of Safety, for aviation Regulatory Authorities to allow a reduction in the original limit descent velocity assumption of 10 fps to a second lower descent velocity assumption, which is subsequently a measured vertical descent velocity; and allow the associated increase to a second higher aircraft maximum landing weight limitation.

Historically systems that measure sink-rate were used either to aid pilots in making flight-path adjustments, thereby improving the pilot's landing technique; or after landing mishaps, to better determine at what point during the landing approach, errors might have been made for adjusting the aircraft descent rates.

As opposed to using aircraft vertical descent measurements prior to the landing event, this invention uses the measurement of aircraft vertical velocity, at the initial contact with the ground, for a different function. This function being to set a determined limit, verified by mechanical measurement, for a safe but abrupt VVG, as a threshold for aircraft inspection; to justify relief in regulatory design criteria and an increase in the aircraft landing weight limitation

Where previous systems have been used as a tool to aid pilots with pre-landing approach procedures, to help avoid hard landing events, this new invention uses the apparatus and methods to increase the economic value of the aircraft, by bringing to better light that current regulations are too stringent; and furthermore by monitoring all subsequent landing events, and having better detection of abrupt landing events, and requiring aircraft inspection triggered by mechanical sensors as opposed to subjective pilots decisions; allows landing at an increased landing weight . . . to be at an Equivalent Level of Safety.

Although an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. A method of operating an aircraft, the aircraft having a first maximum landing weight based upon a first assumed maximum descent velocity, comprising the steps of:
a) obtaining vertical velocities of the aircraft at initial contact of the aircraft with the ground during landing events;
b) based upon the obtained vertical velocities of the aircraft at initial contact with the ground, operating the aircraft at or below a second assumed maximum descent velocity while measuring and recording the vertical velocities of the aircraft at initial contact of the aircraft with the ground during subsequent landing events, the second assumed maximum descent velocity being less than the first assumed maximum descent velocity;
c) operating the aircraft at a second maximum landing weight based upon the second assumed maximum descent velocity.

2. The method of claim 1 wherein the second maximum landing weight is greater than the first maximum landing weight.

3. The method of claim 1 wherein the step of obtaining vertical velocities of the aircraft at initial contact of the aircraft with the ground during landing events further comprises the step of measuring and recording the descent velocities of the aircraft at initial contact of the aircraft with the ground, during landing events.

4. The method of claim 1 wherein the aircraft has landing gear, each landing gear comprising a telescopic strut which is capable of extension and compression, the step of measuring a vertical velocity of the aircraft at initial contact of the aircraft with the ground during subsequent landing events further comprises the steps of:
a) measuring the extension of the one of the telescopic struts before contact of the respective landing gear with the ground;
b) measuring the extension of the one telescopic strut during initial contact of the respective landing gear with the ground;
c) measuring the amount of changed extension of the one telescopic strut with respect to elapsed time;
d) determining the rate of compression of the one telescopic strut;
e) determining the descent velocity of the aircraft portion of the one telescopic strut.

5. The method of claim 1 wherein the aircraft has landing gear, the step of measuring a vertical velocity of the aircraft at initial contact with the ground during subsequent landing events, further comprises the steps of:
a) providing a rangefinder on the hull of the aircraft, the rangefinder directed down at the ground;
b) measuring the distance to the ground of the aircraft over elapsed before the landing gear makes initial contact with the ground;
c) determining when the landing gear makes initial contact with the ground;
d) determining the descent velocity of the aircraft at initial contact by the landing gear with the ground.

6. The method of claim 1 wherein the aircraft has a landing gear, the step of measuring a vertical velocity of the aircraft at initial contact with the ground during subsequent landing events, further comprising the steps of:
a) providing an accelerometer on the hull of the aircraft;
b) measuring the acceleration of the aircraft hull over elapsed time before the landing gear makes initial contact with the ground;
c) determining when the landing gear makes initial contact with the ground;
d) determining the descent velocity of the aircraft at initial contact by the landing gear with the ground.

7. The method of claim 1 wherein the aircraft has landing gear, the step of measuring a vertical velocity of the aircraft at initial contact with the ground during subsequent landing events, further comprises the steps of:
a) providing a global positioning system receiver on the aircraft;
b) measuring the location of the aircraft hull above the ground over elapsed time before the landing gear makes initial contact with the ground;
c) determining when the landing gear makes initial contact with the ground;
d) determining the descent velocity of the aircraft at initial contact by the landing gear with the ground.

8. The method of claim 1 wherein the first assumed maximum descent velocity is 10 fps.

9. The method of claim 8 wherein the step of operating the aircraft at a second assumed descent velocity that is less than 10 fps further comprises the step of operating the aircraft at or below a second assumed descent velocity of 9.8 fps.

10. The method of claim 8 wherein the step of operating the aircraft at a second assumed descent velocity that is less than 10 fps further comprises the step of operating the aircraft at or below a second assumed descent velocity of 9.6 fps.

11. The method of claim 8 wherein the step of operating the aircraft at a second assumed descent velocity that is less than 10 fps further comprises the steps of:
a) measuring and recording the vertical velocity of the aircraft at initial contact of the aircraft with the ground during a landing event;
b) determining if the vertical velocity exceeds a predetermined threshold;
c) if the vertical velocity exceeds a predetermined threshold, then inspecting the aircraft before resuming flight operations.

12. A method of operating an aircraft, the aircraft having a maximum landing weight based upon a first assumed descent velocity, comprising the steps of:
a) measuring and recording the descent velocities of the aircraft at initial contact of the aircraft with the ground, during landing events;
b) determining if a measured descent velocity of the aircraft at initial contact with the ground exceeds a predetermined threshold;
b) inspecting the aircraft, upon determining if the measured descent velocity exceeds the predetermined threshold;
c) operating the aircraft at a second assumed descent velocity that is less than the first assumed descent velocity;
d) operating the aircraft at a second maximum landing weight that is greater than the first maximum landing weight, based upon the second assumed descent velocity.

13. The method of claim 12 wherein the aircraft has landing gear, each landing gear comprising a telescopic strut which is capable of extension and compression, the step of measuring a vertical velocity of the aircraft at initial contact of the aircraft with the ground during a landing event further comprises the steps of:
a) measuring the extension of the one of the telescopic struts before contact of the respective landing gear with the ground;
b) measuring the extension of the one telescopic strut during initial contact of the respective landing gear with the ground;
c) measuring the amount of changed extension of the one telescopic strut with respect to elapsed time;
d) determining the rate of compression of the one telescopic strut;
e) determining the descent velocity of the aircraft portion of the one telescopic strut.

14. The method of claim 12 wherein the aircraft has landing gear, the step of measuring the descent velocity of the aircraft at initial contact with the ground during landing events, further comprises the steps of:
a) providing a rangefinder on the hull of the aircraft, the rangefinder directed down at the ground;
b) measuring the distance to the ground of the aircraft over elapsed time before the landing gear makes initial contact with the ground;
c) determining when the landing gear makes initial contact with the ground;
d) determining the descent velocity of the aircraft at initial contact by the landing gear with the ground.

15. The method of claim 12 wherein the aircraft has a landing gear, the step of measuring the descent velocity of the aircraft at initial contact with the ground during landing events, further comprising the steps of:
a) providing an accelerometer on the hull of the aircraft;
b) measuring the acceleration of the aircraft hull over elapsed time before the landing gear makes initial contact with the ground;
c) determining when the landing gear makes initial contact with the ground;
d) determining the descent velocity of the aircraft at initial contact by the landing gear with the ground.

16. The method of claim 12 wherein the aircraft has landing gear, the step of measuring the descent velocity of the aircraft at initial contact with the ground during landing events, further comprises the steps of:
a) providing a global positioning system receiver on the aircraft;
b) measuring the location of the aircraft hull above the ground over elapsed time before the landing gear makes initial contact with the ground;
c) determining when the landing gear makes initial contact with the ground;
d) determining the descent velocity of the aircraft at initial contact by the landing gear with the ground.
